(19) United States
(12) Patent Application Publication
(10) Pub. No.: US 2010/0215511 A1
(43) Pub. Date: Aug. 26, 2010

(54) Level Sensor System

(76) Inventors: Theodore Eller, Pompano Beach, FL (US); Charles Hart, Davie, FL (US); William Pfarr, Pompano Beach, FL (US); Jim Spraker, Mt. Airy, NC (US)

Correspondence Address: ROBERT M. SCHWARTZ, P.A., P.O. BOX 221470, HOLLYWOOD, FL, 33022, US

(21) Appl. No.: 12/713,707

(22) Filed: Feb. 26, 2010

Related U.S. Application Data
(60) Provisional application No. 61/155,566, filed on Feb. 26, 2009.

(51) Int. Cl. F04B 49/06; G01F 23/00; G08B 21/00

(52) U.S. Cl. 417/44.1; 73/290 R; 340/618

(57) ABSTRACT

A system and method for turning on and off a bilge pump whereby bilge water level is detected using level sensors and bilge pumps are turned on and off based on the detected water level. The system further incorporates an automatic transmission outside the watercraft to alert of the water level in the bilge. The system is controllable from within the watercraft and remotely controllable through wireless transmission.

### CROSS-REFERENCE TO RELATED APPLICATIONS

This application claims priority to U.S. Provisional Application No. 61/155,566 filed on Feb. 26, 2009, the disclosure of which is incorporated herein by reference in its entirety.

### BACKGROUND OF THE INVENTION

A bilge pump is a pump designed to remove bilge water. Because fuel can end up in the bilge compartment, electric bilge pumps are designed not to cause sparks. Electric bilge pumps are often fitted with float switches that turn on the pump when the bilge compartment fills to a set level. Usually, at the level of this float switch, there are opportunities for this mechanical switch to fail.

The present invention addresses a need by providing a system and method for automating the cycle of turning on and off electronic bilge pumps or similar devices.

### BRIEF SUMMARY OF THE INVENTION

The Level Sensor System (LSS) printed circuit board (PCB) provides the real-time control of a device, i.e. a pump and works as a stand-alone system. The Level Sensor System (LSS) provides status information that is sent as events back to a HELM computer for processing and status control via Radio Frequency (RF) and/or power modulated communication systems. If a fluid level has exceeded a predetermined level an event will be sent to the HELM computer for processing and status of the device. The HELM computer can be connected to the internet and/or a wireless provider that then allows users to control and monitor the status of the Level Sensor Module (LSM) and have the ability to control and turn on or off each LSM device.

The present system and method includes level sensors for the detection of the current level of a fluid media being monitored a continuous monitoring and control of the system complete with a Graphical User Interface (GUI) that provides status and over-ride control to and from computer located in the helm or other area.

The helm computer controlling software and GUI provides the status and over-ride controls for the Level Sensor System that are sent to user's cell phones, internet control and/or other connected computers/controllers that are connected to the system.

There are 4 printed circuit boards (PCB) used in the preferred embodiment:

### A Level Sensor Module PCB;

### A Helm (BCM) RF Modem;

An LSM Side Relay RF Controller interface;
An optional GPS; and
An optional DC Powerline Modem,

Level sensing is achieved via capacitive change in a sensor that senses the presence of liquid vs. air. The ratio of water to air is approx 125:1. The change of this ratio is monitored.

The LSM printed circuit contains the sensors and the sensing electronics. The LSM is enclosed in a waterproof, configurable enclosure normally located in a bilge compartment of a boat or ship. It may also be used for tank level sensing of acidic/caustic, high temperature, high pressure, liquid hydrogen/oxygen/nitrogen or waste holding tanks, it may also be used to measure levels inside steel propane tanks or gasoline tanks. The depth of penetration of the sensing field is approximately ¾″ (0.75 inches) currently.

There are two sensors provided in the LSM PCB; a low sensor and a high sensor. Each sensor is separated by approximately 2.5 inches. These sensors control the ON-OFF switch function.

When the fluid level is above the high sensor, the switch activates and remains activated until the fluid level decreases below the low sensor, then the switch deactivates. The switch does not reactivate until the fluid level increases above the high sensor again.

This scheme provides hysteresis and water slosh immunity.

Sensing is achieved by strobing the sensor via the on board microprocessor output pulse and receipt of a response from the sensor. No response from the sensor indicates only air, moderate response indicates mid level or slosh conditions, full response indicates fluid immersion. The microprocessor can intelligently discriminate these conditions and make a decision to activate or not.

The activation is via a 100 amp MOSFET switch electronically controlled via the microprocessor.

The level sensor PCB is powered by the vessel battery bus; the integral dc regulator is capable of a 6V-80V dc input and is immune to power bus transients including starter noise.

The complete LSM PCB draws less than 1 milliamp nominal, making it ideal for long term battery operations.

The LSM PCB is an autonomous (stand alone) device, some options are available and described below.

The LSM PCB can communicate status and control to an RF transceiver located in the area of the LSM. This RF link is an option which communicates with the BCM (bridge command module). The BCM includes at least a computer and a communications system.

Within this link, the BCM becomes the master controller and the LSM becomes the slave device. Many LSMs (32) can be controlled by only one BCM using only one RF channel.

The BCM commands or controls the LSM actuators to turn one or more devices, such as a bilge pump, ON or OFF at any time, overriding the LCM in event of an LCM failure or based on user demand. The BCM also retrieves and logs status, including level, activation, and temperature history of the LSM's. This can be achieved using RF communications without any additional wiring or breakers in the vessel electrical panel.

The BCM is mounted in the bridge area of a boat or ship. The BCM monitors bilge, temperature, and battery status of each LSM and saves a historical event record. The BCM provides a GUI readout of all such LSM parameters.

The LSM is expandable via daughterboard inserts inside its enclosure.

Daughterboard options include GPS at the LSM and ultra low power powerline modulation modules to communicate from the LSM to the BSM over a powerline within the vessel.

There are several software packages that work together to provide the monitoring and control of this system which are described below:
The Helm Software can provide at least the following functions:
   Fluid Level detection at each LSM, for example; the rate of fluid level rise and fall,
   Present level ambient temperature in degrees F. and degrees C. at the LSM,
   System Status Warnings, provided in Voice, text, graphical and Digital formats to the users
   Status Message Center providing status for the (present Battery Level, temperature, and general system condition, Pump(s) status, Voice Status,
   Voice Status Alerts,
   Temperature alerts,
   Fluid Level status,
   Graphical Fluid Level indicator,
   Optional GPS at the helm BCM with (Latitude, Longitude, Altitude, Speed and Heading),
   Master Power Control for the Pump control system,
   Master Relay Controller with a RF interface,
   Sensory interface to the fluid level sensor pcb system, automatic control of connected pumps that also provide simultaneous feedback to the GUI showing the present status and conditions,
   Pump over-ride for all connected pumps,
   Voltage monitoring of all connected pumps and controls to provide feedback that the actions requested have occurred,
   Optional: active internet connection and monitoring,
   Optional: active emailing system to send status and alarms to the user,
   Optional: cell phone text and SMS messaging,
   Optional: cell phone Control of the device under control, i.e. turn on and off of a defined pump,

### Level Sensory Microcontroller (Level Sensor Module PCB):

The software for the microcontroller on the Level Sensor Module provides the continuous monitoring of the fluid levels and provides these levels via signals that are sent to the main Helm Software for processing and control.
This software also provides for alarms and alerts that are sent in real time from the LSM to the main Helm software that provides monitors and status controls of the system.
This software performs averaging of the signals to adjust for fluid splashing and generating false alarms or allowing the pumps to run without fluid or to be on when fluid has just splashed against the sensors.
Each of these 4 PCB's are providing the functions as listed in the Software section as shown above.

### GPS Microcontroller:

This microcontroller software provides the continuous monitoring of 3 to 12 satellites providing the Latitude, Longitude, Altitude, Speed and Heading that is passed to the Helm Software once per second for display and can be sent via emails or voice and messaging alerts to a user.
This microcontroller is bidirectional and it receives commands from the Helm Software and responds with a corresponding data request.

### GPS:

The GPS Receiver Module provides standard, raw NMEA0183 (National Marine Electronics Association) strings or specific user-requested data via the serial command interface, tracking of up to 12 satellites, and WAAS/EGNOS (Wide Area Augmentation System/European Geostationary Navigation Overlay Service) functionality for more accurate positioning results.
The Module provides current time, date, latitude, longitude, altitude, speed, and travel direction/heading, among other data, and can be used in a wide variety of commercial applications, including navigation, tracking systems, mapping, fleet management, and auto-pilot.

A Graphical User Interface (GUI) can be design to have the look of any application or customized for the USER requirements such as colors, logos, positions of controls, control shapes, etc. . . . .

The system provides many means to allow the control and monitoring of the present status of the pump and the surrounding area. This data is available to be sent via emails, SMS messages, MMS as needed, Internet Page uploads as needed, to Cell Phone applications for the monitoring and control of Bilge Pumps and the control/monitoring system from remote locations.

Although the invention is described herein as a level sensor system for monitoring water in a bilge compartment and control of bilge pumps, the present invention is useful for monitoring a liquid level for any type of liquid in any container and for actuating an event based on liquid levels being monitored.

In one embodiment, the present invention is a system for operating a marine bilge pump, including:

a. at least one sensor for detecting the presence of liquid, primarily water;
b. a first electronic transceiver operatively associated with the sensor;
c. a second electronic transceiver communicatively associated with the first electronic transceiver;
d. a device operatively associated with each of the transceivers; and
e. an actuator for controlling power and operation of the device;
the sensor, when actuated, transmitting a signal to a master controller, the first transceiver sending a signal to the second transceiver and the second transceiver processing the signal in the master controller, which subsequently sends a signal to the device to initiate or cease operation.

In one embodiment, the system utilizes a sensor in the bilge compartment of a marine watercraft. This sensor is constructed and arranged to create electromagnetic sensing field lines up to ¾ of an inch outward from the surface of the sensor.

In another particular embodiment, the first electronic transceiver receives information from the sensor regarding the presence or absence of a liquid (such as water, bilge, etc.) at the sensor, and transmits information relating to presence or absence of the liquid to a bridge command module. In this embodiment, the bridge command module is operatively associated with a second electronic transceiver. The bridge command module is constructed and arranged to receive information from the sensor, via the first electronic transceiver, and to transmit information in response to information received from the sensor. In particular, information transmitted by the bridge command module can include an instruction or instructions to actuate a bilge pump or other desired device.

In one particular embodiment used on a watercraft, the information transmitted by the bridge command module includes an instruction relating to the actuation of a bilge pump, in response to which the bilge pump is turned on or turned off.

In another particular embodiment, the system is further configured, upon transmission of information to start or stop a device, to include initiation or cessation of an indicator, such as a visual signal, an audio signal, or combinations thereof.

The system can further include a device for communicating with a cellular device. For example, in one particular embodiment, the system is programmed to communicate with at least one pre-programmed mobile, satellite and/or cellular device by SMS messaging.

In another particular embodiment of the invention, the system has a bridge command module constructed and arranged to automatically turn on and/or turn off said bilge pump in response to information received from a sensor. The bridge command module of this embodiment is also constructed and arranged to manually turn on and/or turn off said bilge pump or other device in response to information received from the sensor. Further, the bridge command module is constructed and arranged to remotely turn on and turn off the bilge pump or other device. Remote operation may be from a computer, mobile phone (such as a cellphone, satphone, smartphone, etc.) or other device. If desired, in one embodiment of the invention, the bridge command module can also communicate with a Bluetooth transmission mechanism. Additionally, in another embodiment of the invention, the system can receive information from Global Positioning Satellites.

In another embodiment of the invention, the system can convert a radio frequency signal to a WiFi signal.

In a further embodiment of the invention, a first electronic transceiver wirelessly communicates with a second electronic transceiver. In another embodiment, the first electronic transceiver wirelessly communicates with the second electronic transceiver via DC power line modulation. If desired, communication via both wireless and DC modulation can be used. In such a system, the communication may be selective as to wireless or DC powerline modulation, or may be redundant, communicating simultaneously by wireless communication and by DC powerline modulation.

The first electronic transceiver is operatively associated with a level sensor module that utilizes an algorithm to decide on starting and stopping of a device, such as a bilge pump.

The algorithm decides on starting and/or stopping the device and can include a time delay for starting and/or stopping the device.

In one embodiment, the optional DC power line modulation uses existing wiring in a marine watercraft.

In another embodiment, the bridge command module queries each sensor at predetermined time intervals.

Additionally, in one embodiment, the bridge command module can transmit information in response to information received from the sensor by sending at least one of: an Internet transmission, an email, a transmission to a monitoring station, or combinations thereof and can be configured for multiple transmissions at predetermined time intervals.

The system can also allow for the remote control of a device, such as a bilge pump, based upon receipt of an instruction from a cell phone, an Internet website, a monitoring service, or combinations thereof.

In another embodiment of the invention, a system for monitoring a liquid level in a container is provided, including:

a. at least one sensor for detecting the presence of liquid;
b. a first electronic transceiver operatively associated with a sensor;
c. a second electronic transceiver communicatively associated with the first electronic transceiver;
d. a device operatively associated with each of said the first and second electronic transceivers; and
e. an actuator for controlling power and operation of the device;
the sensor, when actuated, transmitting a signal to a master controller, the first transceiver sending a signal to the second transceiver, the second transceiver processing a signal in the master controller, which, subsequently, sends a signal to the device to initiate or cease operation of the device.

### BRIEF DESCRIPTION OF THE DRAWINGS

FIG. 1 is a block diagram illustrating the communication between a bridge command module and a plurality of level sensor.

FIG. 2 is a diagram showing a vertical arrangement of field effect level sensors above a floor of a liquid chamber in accordance with one embodiment of the invention.

FIG. 3 is a diagram showing the vertical arrangement of field effect level sensors of FIG. 2, and including, for illustrative purposes, a liquid level proximate to a first sensor.

FIG. 4 is a diagram showing the vertical arrangement of field effect level sensors of FIG. 2, and including, for illustrative purposes, a liquid level at proximate to a second sensor.

FIG. 5 is a diagram showing the vertical arrangement of field effect level sensors of FIG. 2, and including, for illustrative purposes a liquid level proximate to a third sensor.

FIG. 6 is a diagram illustrating components of the present system residing within a fluid chamber (not shown) in accordance with an embodiment of the instant invention.

FIG. 7 is a diagram illustrating components located outside of a fluid chamber in accordance with one embodiment of the invention, those components communicate with components disposed within the fluid chamber as shown in FIG. 6.

FIG. 8 is a flowchart of the operation of a system in accordance with one particular embodiment of the invention.

FIG. 9 is a flow chart of communications in the system of the present invention.

FIG. 10 is a block diagram of the components of a level sensor module in accordance with one particular embodiment of the present invention.

FIG. 11 is a diagram showing a vertical arrangement of field effect level sensors above a floor of a liquid chamber in accordance with another embodiment of the invention.

### DETAILED DESCRIPTION OF THE PREFERRED EMBODIMENTS

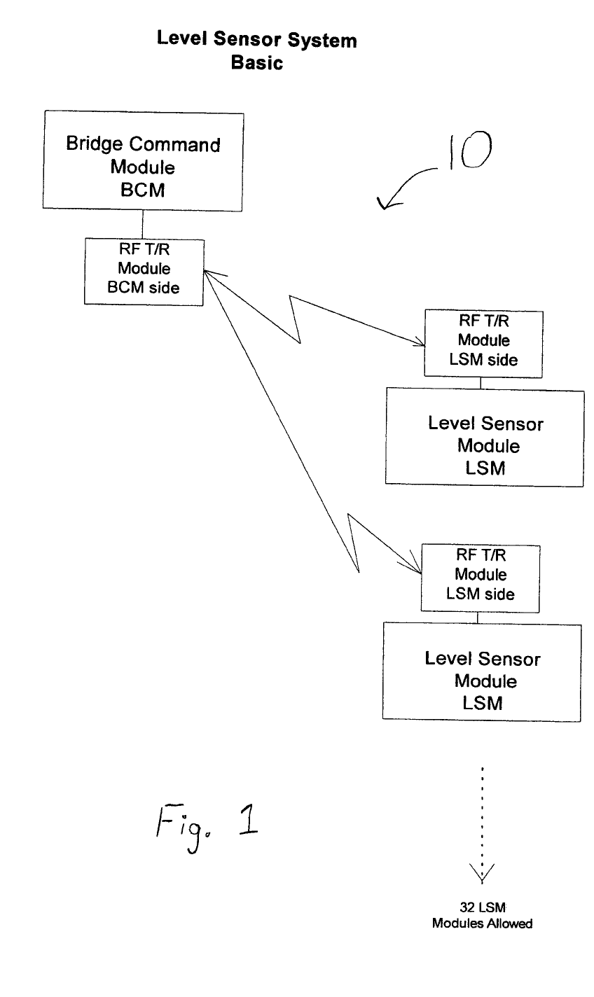

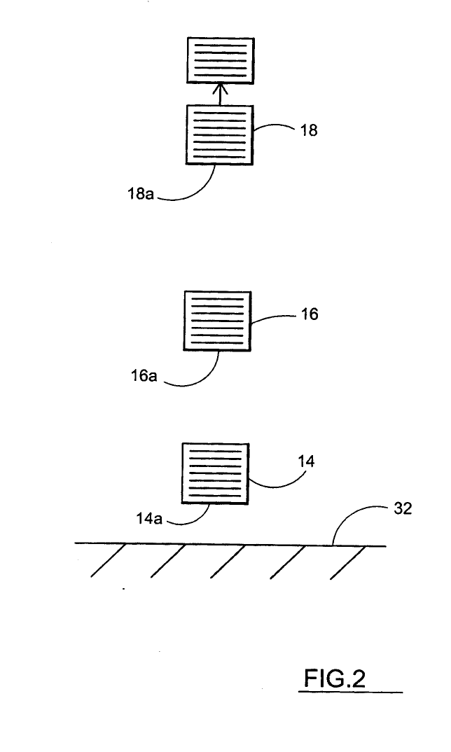

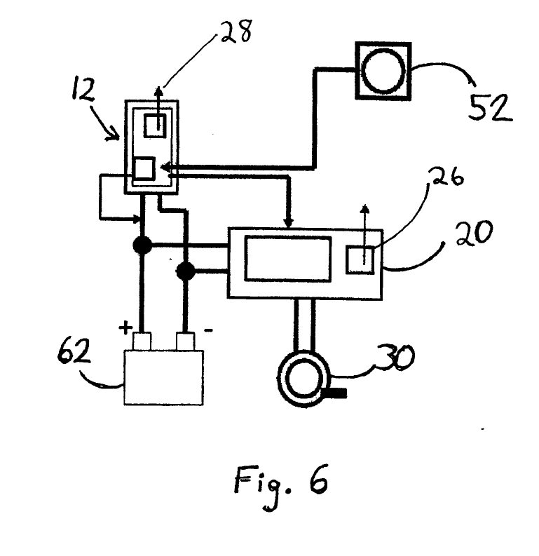

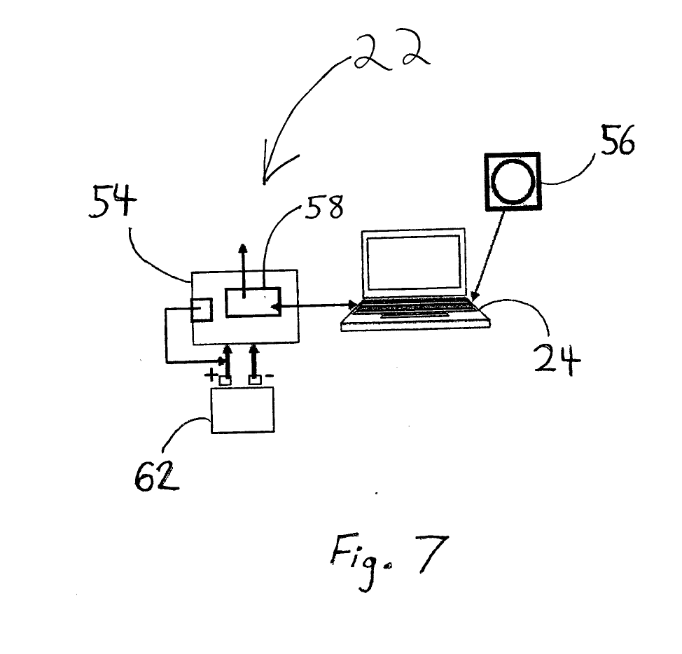

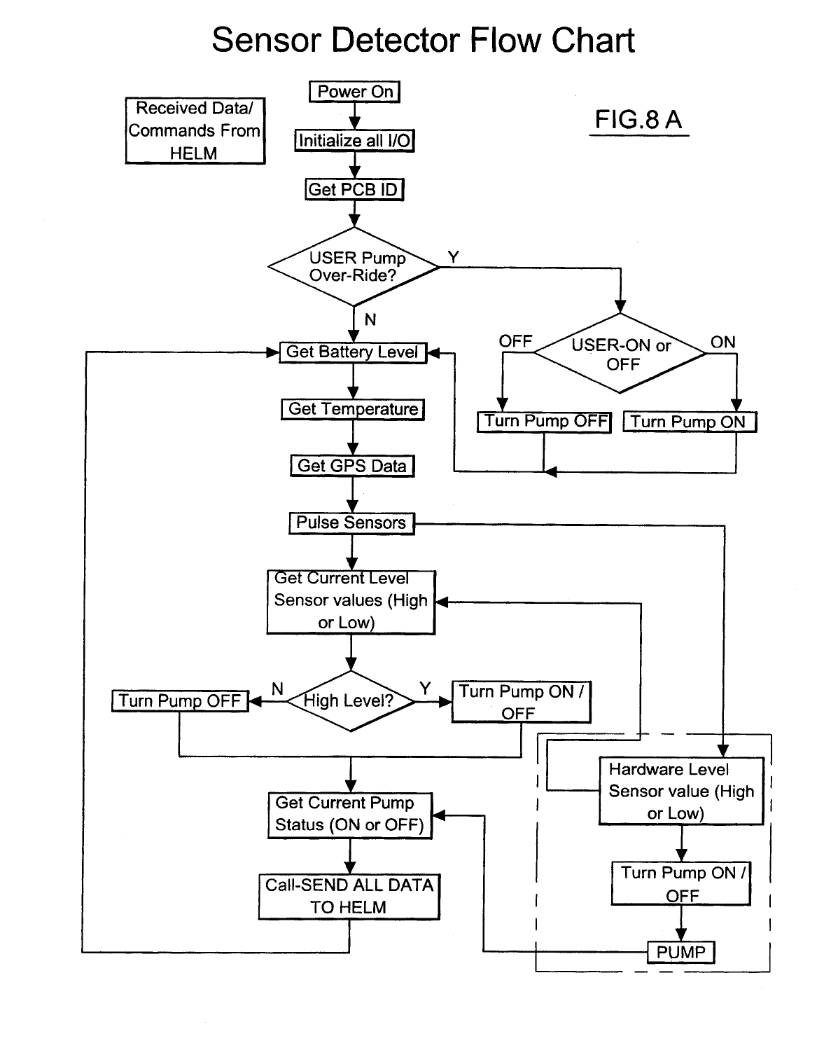

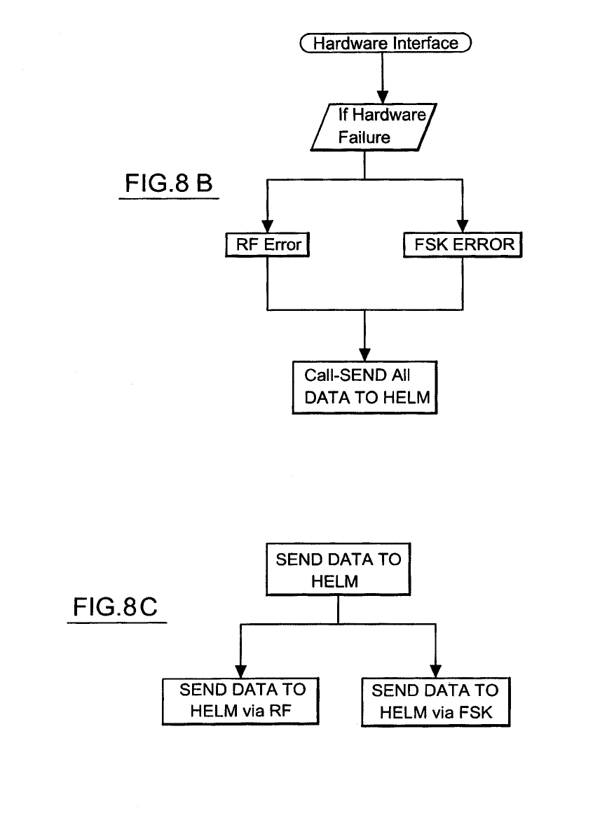

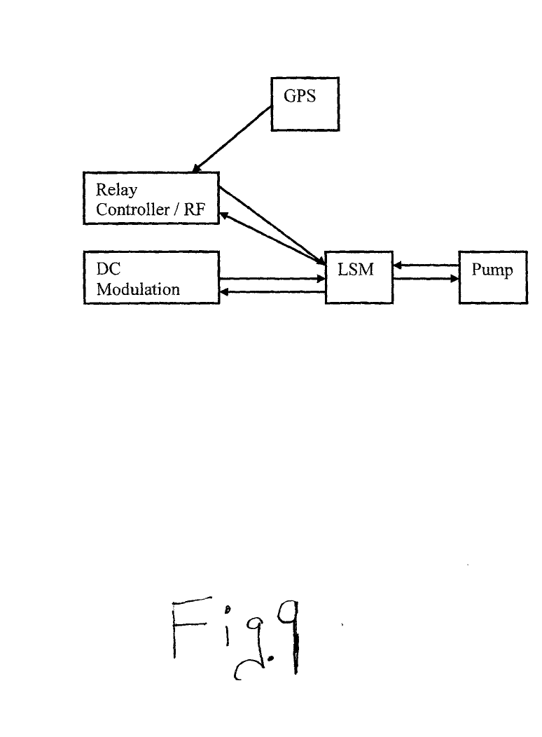

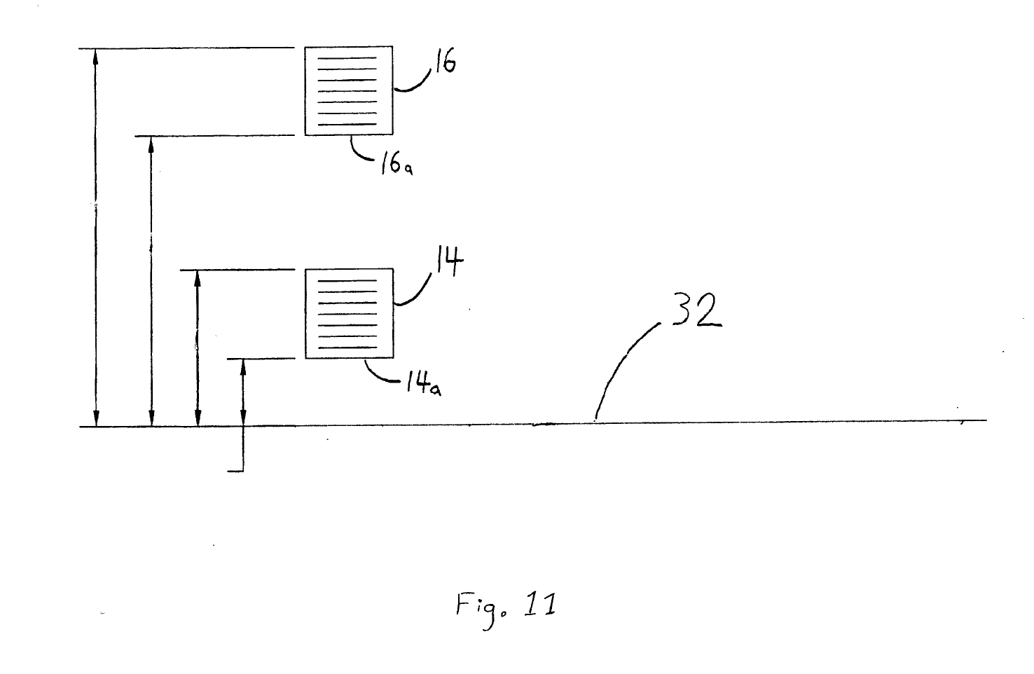

Referring now to FIGS. 1-6 and 11, System 10 includes a level sensor module (LSM) 12 which has contained therein a first, low sensor 14, and a second, high sensor 16. Optionally, level sensor module 12 can have a fewer number or greater number of sensors, for example, in one particular embodiment, shown in FIGS. 2-5, the LSM 12 includes a third, high high sensor 18. Each of low sensor 14 and high sensor 16 are positioned vertically above the bilge compartment section floor 32 of a waterborne vessel.

In one embodiment, the lower edge 14a of low sensor 14 is about 0.750 inches above bilge compartment floor 32. The lower edge 16a of high sensor 16 is about 4.25 inches above bilge compartment floor 32. In an embodiment using a high high sensor 18, lower edge 18a of high high sensor 18 is about 7.25 inches above bilge compartment floor 32. Level sensor module 12 has associated therewith, LSM microprocessor module 20.

Microprocessor module 20 controls: LSM 12; actuating mechanism for activating and deactivating bilge pump 30; and includes transceiver 26 with wireless and direct wired communications to bridge command module (BCM) 22. Microprocessor module 20 communicates with BCM 22 by wireless RF through transceiver 26 and direct wired communication. Bridge command module 22 has a bridge command module microprocessor 24 associated therewith that is constructed and arranged to monitor and control system 10. Bridge command module microprocessor 24 communicates with level sensor microprocessor 20 using bridge transceiver 54 to receive and transmit information in communication with LSM transceiver 26 operatively associated with field level sensor module 12. One embodiment incorporates an RF antenna 28 with transceiver 26. In one embodiment, bridge command module 22 is further constructed and arranged to signal a transmitter that is preprogrammed to dial one or more telephone numbers when actuated. In one embodiment, such a transmitter is a blue tooth transmitting device.

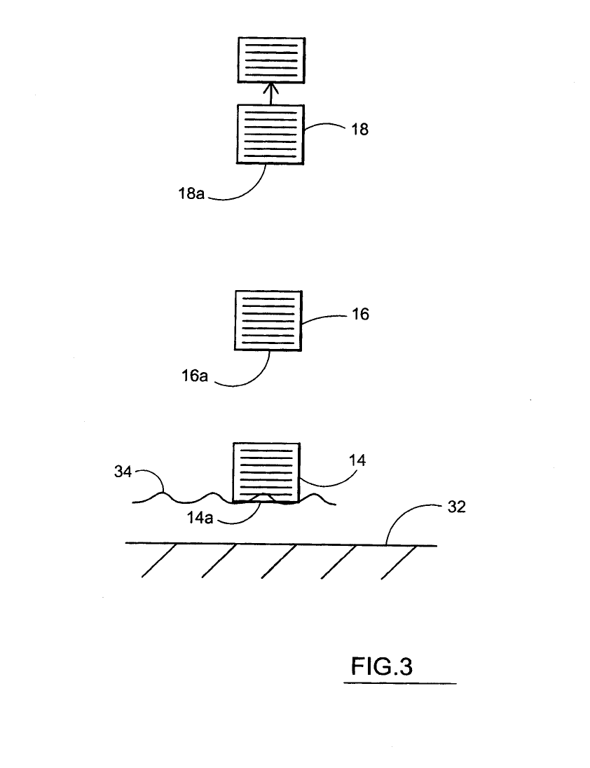

System 10 detects water levels above the bilge compartment floor 32 of a boat or watercraft. Water level 34, as shown in FIG. 3, above bilge compartment floor 32 is above lower edge 14a of low sensor 14. Therefore, low sensor 14 will actuate the bilge pump 30 which will operate and turn on and off based on water level 34.

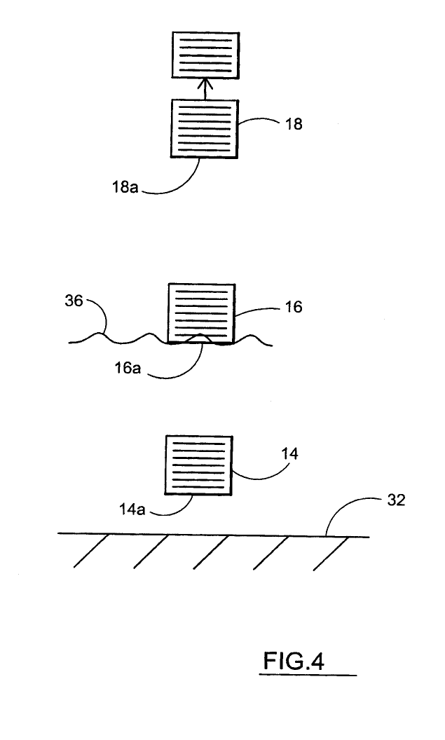

Water level 36, as shown in FIG. 4, is above lower edge 16a of high sensor 16. High sensor 16 actuates pump 30 in response to water level 36 detected at high sensor 16. When water level 36 is present above bilge compartment floor 32, level microprocessor 20 initiates transmission of water level information from transceiver 26 to BCM transceiver 58. Transceiver 58 may incorporate an RF or similar antenna as needed. Bridge command module 22 directly actuates and turns on bilge pump 30 through LSM microprocessor 20.

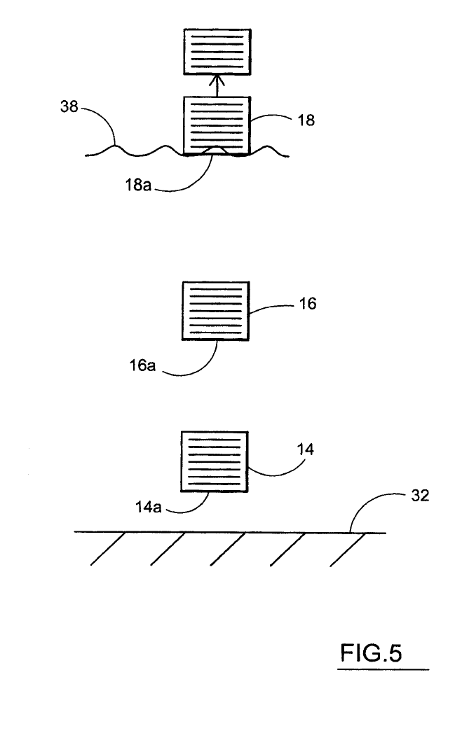

In an embodiment with a high high sensor 18, water level 38 is above lower edge 18a of high high sensor 18, as shown in FIG. 5. High high sensor 18 actuates bilge pump 30 through LSM microprocessor 20 and turns on in response to water level 38 detected at high high sensor 18.

System 10 of the present invention uses RF communications within the vessel to replace the cables connecting portable and/or fixed electronic devices within the system 10 of the invention.

The RF communications is also used to communicate from the vessel to, for example, a pre-programmed cellular telephone number of the boat owner's choice to alert of a high-water condition within their boat.

Each sensor 14, 16, and 18 is in communication with level sensor module 12 of system 10 and level sensor module 12 communicates with Bridge Command Module 22.

System 10 has level sensor module 12 configured to communicate with level microprocessor 20. Level microprocessor 20 has a transceiver 26 that utilizes a transition rate of (20) transitions per second. Microprocessor 20 is also configured as an encoder that receives control inputs and address bits from LSM 12, it than serializes both inputs, and feeds the serialized bits into transceiver 26 that sends the bits as RF data and control to BCM transceiver 58.

System 10 has a bridge command microprocessor 54 in communication with each of level microprocessor 20 and bridge command module 24.

A power supply regulator 78 from battery 62 is constructed and arranged to provide desired DC output of 5V DC. Mofset switch 60 is actuated by bridge commend module 24 and controls bilge pump 30 through LSM microprocessor 20. Although the figures show a single bilge pump 30, it is known in the art that watercraft may have a plurality of bilge pumps.

A Radio Frequency (RF) Module transceiver 26 and 58 receives the RF data and feeds it into the decoder, which de-serializes it, compares address bits, and outputs the control data as parallel bits. Decoder outputs can both source and sink 5 volts at 25 milliamps each, thus outputs are low when no signal is received and go high to +5 volts when signal is received.

The 415 MHz frequency is in the ISM band range, which is utilized by industrial, scientific and medical industries.

The power supply 62 regulates input power to a preferred 5V for microprocessor 20 and 12V to transceivers 26 and 58.

Both transceivers 26 and 58 are powered by a regulated 5V DC.

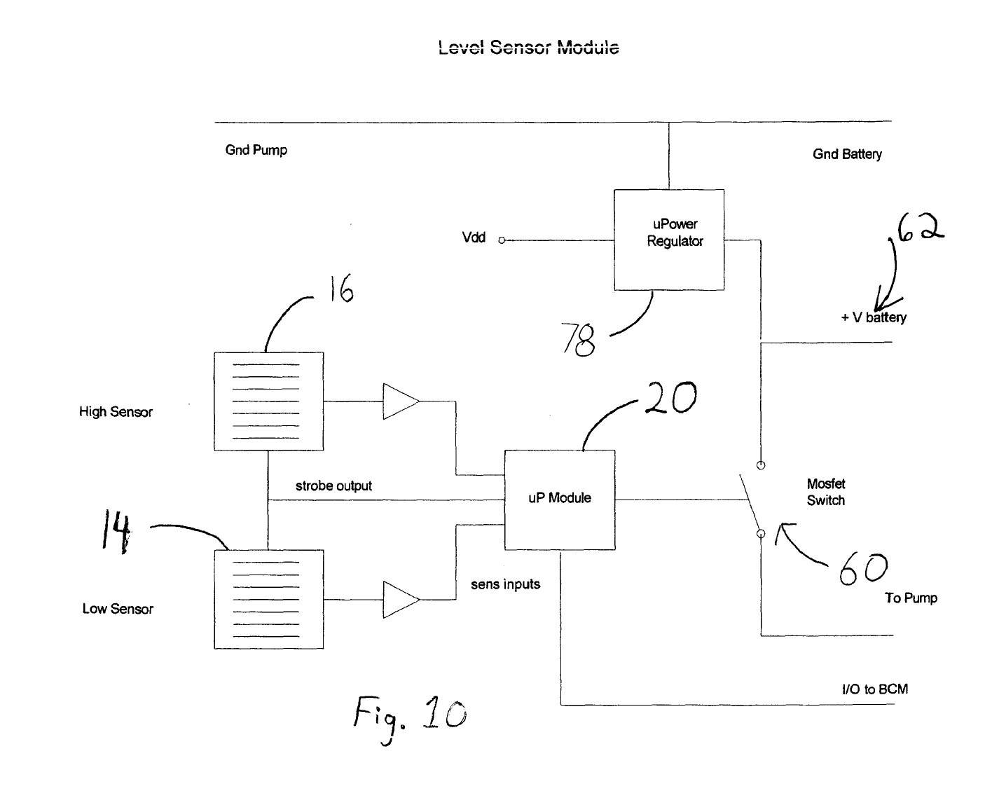

User Control: FIG. 10 is a screenshot for the Graphical User Interface (GUI). This GUI can be configured to have the look of any application or customized for the USER requirements such as colors, logos, positions of controls, control shapes, etc. . . . .

Remote Monitoring: System 10 provides many means to allow the control and monitoring of the present status of the bilge pump and the surrounding area. This data is available to be sent via emails, SMS messages, MMS as needed, Internet Page uploads as needed, Cell Phone applications for the monitoring and control of the Bilge Pumps and the control/monitoring system.

The Bridge command module 24 is the master controller; the level sensor module 20 units are the slave modules. The Bridge command module 24 master polls all the level sensor module 20 slaves (up to 32) once per minute and waits for a response from each of the addressed slave modules until proceeding or defaults to the next slave module after time out.

In one embodiment, the LSM operates as a stand alone unit and actuates on and off operations of bilge pump 30.

While the invention has been described in its preferred form or embodiment with some degree of particularity, it is understood that this description has been given only by way of example and that numerous changes in the details of construction, fabrication, and use, including the combination and arrangement of parts, may be made without departing from the spirit and scope of the invention.

We claim:

1. A system for operating a marine Bilge pump comprising:
a. at least one sensor for detecting the presence of liquid;
b. a first electronic transceiver operatively associated with said sensor;
c. a second electronic transceiver communicatively associated with said first electronic transceiver;
d. a device operatively associated with said each of said transceivers; and
e. an actuator for controlling power and operation of said device;
wherein said sensor, when actuated, transmits a signal to a master controller, said first transceiver sends a signal to said second transceiver and said second transceiver, processes said signal in said master controller that subsequently sends a signal to said device to initiate or cease operation.

2. The system of claim 1 wherein said sensor is in the bilge compartment of a marine watercraft

3. The system of claim 1 wherein said sensor is constructed and arranged to exhibit electromagnetic sensing field lines up to ¾ inch outward from the surface of said sensor.

4. The system of claim 1 wherein said first electronic transceiver receives information from said sensor regarding the presence of water at said sensor, and said transmits information relating to said presence of water to a bridge command module.

5. The system of claim 1 wherein said second electronic transceiver is operatively associated with a bridge command module.

6. The system of claim 5 wherein said bridge command module is constructed and arranged to receive information from said sensor and to transmit information in response to information received from said sensor.

7. The system of claim 6 wherein said transmission of information comprises instructions to actuate a bilge pump or device.

8. The system of claim 7 wherein said actuation of said bilge pump is an instruction to turn on or turn off said bilge pump or device.

9. The system of claim 6 wherein said transmission of information comprises initiation of a visual signal, audio signal, or combinations thereof.

10. The system of claim 6 wherein said transmission further comprises communication with a cellular device.

11. The system of claim 6 wherein said transmission comprises communication with at least one preprogrammed cellular device by SMS messaging.

12. The system of claim 6 wherein said bridge command module is constructed and arranged to automatically turn on and turn off said bilge pump in response to information received from said sensor.

13. The system of claim 6 wherein said bridge command module is constructed and arranged to manually turn on and turn off said bilge pump or device in response to information received from said sensor.

14. The system of claim 6 wherein said bridge command module is constructed and arranged to remotely turn on and turn off said bilge pump or device in response to information received from said sensor.

15. The system of claim 6 wherein said bridge command module is constructed and arranged to communicate with a Bluetooth transmission mechanism.

16. The system of claim 1 constructed and arranged to transmit and receive by Global Positioning Satellite.

17. The system of claim 1 constructed and arranged to convert a radio frequency signal to a WiFi signal.

18. The system of claim 1 wherein said first electronic transceiver wirelessly communicates with said second electronic transceiver.

19. The system of claim 1 wherein said first electronic transceiver communicates with said second electronic transceiver by optional DC power line modulation.

20. The system of claim 1 wherein said first electronic transceiver is operatively associated with a level sensor module.

21. The system of claim 20 wherein said level sensor module utilizes an algorithm to decide on starting and stopping said bilge pump.

22. The system of claim 21 wherein said algorithm to decide on starting and stopping said bilge pump includes a time delay for starting and stopping said bilge pump.

23. The system of claim 19 wherein said optional DC power line modulation uses existing wiring in a marine watercraft.

24. The system of claim 5 wherein said bridge command module queries said sensor at predetermined time intervals.

25. The system of claim 6 wherein said bridge command module transmission of information in response to information received from said sensor comprises sending at least one Internet transmission.

26. The system of claim 25 wherein said Internet transmission is sent to at least one email address, a monitoring station, or combinations thereof.

27. The system of claim 6 wherein said transmission of at least one Internet transmission comprises multiple transmissions at predetermined time intervals.

28. The system of claim 14 wherein said remote control of said bilge pump is based upon receipt of an instruction from a cell phone, Internet website, monitoring service, or combinations thereof.

29. The system of claim 1 wherein said liquid is water.

30. A system for monitoring a liquid level in a container comprising:
a. at least one sensor for detecting the presence of liquid;
b. a first electronic transceiver operatively associated with said sensor;
c. a second electronic transceiver communicatively associated with said first electronic transceiver;
d. a device operatively associated with said each of said transceivers; and
e. an actuator for controlling power and operation of said device;
wherein said sensor, when actuated, transmits a signal to said a master controller, said first transceiver sends a signal to said second transceiver and said second transceiver, processes said signal in said master controller that subsequently sends a signal to said device to initiate or cease operation.

31. A system for monitoring a liquid level in a container comprising:
a. at least one sensor for detecting the presence of liquid, wherein said sensor is operatively associated with an actuator to turn on or off a device based on the level of liquid in said container.
